(19) United States
(12) Patent Application Publication
(10) Pub. No.: US 2009/0242271 A1
(43) Pub. Date: Oct. 1, 2009

(54) Lightweight electric conductor assembly

(76) Inventor: Jan Vetrovec, Larkspur, CO (US)

Correspondence Address: Aqwest LLC, P.O. BOX 468, Larkspur, CO, 80118, US

(21) Appl. No.: 12/383,727

(22) Filed: Mar. 27, 2009

Related U.S. Application Data
(60) Provisional application No. 61/072,172, filed on Mar. 28, 2008.

(51) Int. Cl. H01B 1/00

(52) U.S. Cl. 174/70 R

(57) ABSTRACT

The invention provides a lightweight electric conductor capable of storing waste heat induced by intermittent high currents. The conductor comprises a high electric conductivity (HEC) element and a phase change material (PCM) arranged in a thermal contact therewith. In one preferred embodiment, the HEC element is formed as a tubular member having longitudinal cavity substantially filled with PCM. In another embodiment of the subject invention, the HEC element may be formed as a long rod, bar, or a wire having PCM applied to, and in thermal communications with its exterior surface. Waste heat generated by passage of intermittent high electric through the HEC element generates waste heat that is conducted into the PCM and temporarily stored therein as latent heat. The invention allows reducing the cross-section of electrically conducting parts of electric conductors used for intermittent high currents. As a result, the conductor weight is reduced. The innovative lightweight conductor may be used in hybrid electric vehicles and certain electric weapons systems.

### CROSS-REFERENCE TO RELATED APPLICATIONS

This application claims priority from the U.S. provisional patent application U.S. Ser. No. 61/072,172, filed on Mar. 28, 20087.

### FIELD OF THE INVENTION

This invention relates generally to electric conductors and more specifically to lightweight electric conductors for handling of intermittent high electric currents.

### BACKGROUND OF THE INVENTION

There are many electric devices having electric conductors that carry high electric currents for several seconds to several tens of seconds with long periods of downtime between consecutive high-current operations. Often such devices are a part of a larger system, which may be operated on a mobile platform such as a land vehicle, aircraft, or spacecraft. In mobile systems, there is an emphasis to reduce weight in order to improve energy efficiency.

One example of such a mobile platform is a hybrid electric vehicle (HEV) using a battery-operated electric motor to supplement an internal combustion engine during periods of high power demand, such as acceleration or hill climbing. It has been shown that periods of such a high power demand represent on the average only about 10% of total vehicle operating time. Hybrid electric propulsion system allows the use of a smaller internal combustion engine and thus improves the overall vehicle's fuel efficiency. However, hybrid system's batteries and electric motor add weight to the vehicle, thereby significantly limiting the potential benefits of the HEV. Substantial portion of hybrid system's weight may be attributed to electric conductors requiring to carry high electric current when the electric drive is engaged. Electric weapons such as certain high-power microwave systems and high-power laser systems for intermittent operation on mobile platforms also use high electric currents. Lightweight electric conductors would allow substantial weight reduction of these systems.

Electric Conductors: Conventional electric conductors are normally rated for continuous service. Most electric conductors are made of copper material having rather high density of about 8.9 grams per cubic centimeter. To avoid overheating due to resistive (ohmic) losses generating waste heat, the conductor cross-section for a given conductor material is made sufficiently large so that the losses are small and the waste heat can be dissipated into air or adjacent components. As a result, conductors rated for continuous service are relatively heavy. In some high-current applications, the conductor is made hollow by incorporating an internal longitudinal passage. For example, such a hollow conductor may be configured as a tube. A suitable cooling fluid (e.g., water) may be flowed through the passage to remove waste heat. However, systems using flowing cooling fluids are more complex and, therefore, less desirable for mobile applications.

For intermittent applications, the conductor may be lightened by reducing its cross-section. However, this increases the electric resistance of the conductor (and increases generation of waste heat) while reducing its thermal capacity. As a result, such a conductor may experience relatively rapid temperature rise, which limits its useful operating time. Therefore, reducing conductor cross-section alone to save weight for intermittent application produces very limited benefits.

Using aluminum rather than copper as a conductor material has the advantage of reduced density (about 3.5 times less than copper), which is in-part offset by the higher electrical resistivity of aluminum (about 30% higher than copper). However, aluminum conductor is generally considered less reliable than cooper conductor, which is in-part due to its lower melting point and generally lower ductility.

Phase Change Materials: For the purposes of this invention, a material that changes in heat content upon undergoing a reversible solid-liquid phase transformation is defined as a phase change material (PCM). PCMs, synonymously known as latent thermal energy storage materials, are used for thermal energy storage. The absorption of the necessary quantity of energy by the solid PCM results in melting. The energy absorbed by the PCM to change phase at its characteristic melting temperature is known as the latent heat of fusion. The latent heat of fusion stored in the liquid state is released upon resolidification. Thus the PCM may absorb thermal energy from a body at a higher temperature than the PCM, until the PCM undergoes a reversible melt. A molten PCM may transfer thermal energy to a body at a lower temperature than the PCM and it may thereby undergo a reversible solidification (freeze).

Efficient PCMs have several desirable thermo-chemical properties including high latent heat of fusion, high thermal conductivity, low supercooling, and the ability to cycle thermally from solid to liquid and back to solid many times without degradation. The term “supercooling” refers to a discrepancy between the temperature at which solidification (freezing) initiates and the melting temperature of a given PCM when cooled and heated under quiescent conditions. A significant amount of PCM research is devoted to finding nucleating agents additives that will suppress supercooling. The term “additives” includes, in addition to nucleating agents, precursors of such additives which are non-detrimental to the function of the phase change materials. Considerations for selection of suitable PCMs may also include melting temperature, density, packaging, toxicity and cost. Many suitable PCM have a very low density, generally less than 2 grams per cubic centimeter and, in many cases, less than 1 gram per cubic centimeter.

Certain types of PCM do not turn into liquid upon melting. These include a cross-linked polyethylene (PEX) which has a melting point in the range of 110-115 degrees Centigrade, and a cross-linked high-density polyethylene (HDPEX) which has a melting point in the range of 125-146 degrees Centigrade. PEX and HDPEX are known to contain cross-link bonds in the polymer structure, which change these thermoplastic materials into an elastomers. The cross-link bonds permit PEX and HDPEX to undergo a phase change transition (melting) accompanied by its characteristic absorption of heat without turning into liquid.

In summary, there is a need for means and methods that would allow an electric conductor to handle temporary increase in electric current without the need to increase the conductor weight or to operate the conductor at an excessive temperature. Suitable means should be very compact, lightweight, and inexpensive to manufacture and integrate into mobile systems, especially the electric propulsion system of hybrid electric vehicles.

### SUMMARY OF THE INVENTION

The present invention provides a lightweight electric conductor assembly capable of storing waste heat induced by intermittent high electric currents. The innovative electric conductor assembly comprises a high electric conductivity (HEC) element and a phase change material (PCM) arranged in a thermal contact with the HEC element. Preferably, the HEC element is made of material having high electric conductivity, such as but not limited to copper, copper alloys, aluminum, and aluminum alloys.

In one preferred embodiment of the invention, the HEC element is formed as a tubular member having longitudinal cavity. The PCM is arranged to substantially fill the longitudinal cavity. In some variants of the invention, the thermal contact between the HEC element and the PCM may be enhanced by adding surface extension (such as protrusions, undulations, grooves, ribs, or fins) to the walls of the longitudinal cavity. Any suitable PCM having desired melting point may be used. If the selected PCM turns into liquid upon melting, the ends of the longitudinal cavity may be plugged to prevent molten PCM from leaving the cavity. The PCM may also include material for enhancement of thermal conduction. The PCM may also include a suitable elastic material that can accommodate dimensional changes of the PCM due to melting or solidification without excessively increasing the hydrostatic pressure in the PCM. In this fashion, excessive stresses on, and a possible damage to the HEC element are avoided.

In operation, high electric current passing through the HEC element generates waste heat that is deposited into the HEC material and raises its temperature. At least a portion of the waste heat is conducted to the PCM and also raises its temperature. When the PCM temperature reaches its melting temperature, further addition of heat gradually melts the PCM. As the waste heat is deposited into melting of the PCM, it may not significantly contribute to further temperature increase of the HEC element and the PCM. Electric current passing through the HEC is preferably reduced before all of the PCM is melted. Heat stored in the PCM may be gradually removed from the PCM by conducting it back to the HEC element and transferring it from the HEC element surface to environment or adjacent components. As the heat is removed from molten PCM, the PCM may gradually solidify. The exterior surface of the HEC element may also include surface extensions such as undulations, groves, fins, or ribs to enhance transfer of heat from the conductor to environment.

In another embodiment of the subject invention, the HEC element may be formed as a long rod or a wire having PCM applied to, and in thermal communications with its exterior surface. For example, the PCM can be applied in a form of a jacket to the exterior surface of the HEC element. Preferred PCM for use with this embodiment include materials that do not turn into liquid upon melting, such as cross-linked polyethylene (PEX) and a cross-linked high-density polyethylene (HDPEX). This allows PEX and HDPEX PCM to be used on the outside of HEC element without encapsulation in another material. Since PEX and HDPEX are electrically insulating materials, they may simultaneously provide two functions: electric insulation and heat storage. The exterior surface of the HEC element may include surface extensions such as undulations, groves, fins, or ribs to enhance transfer of heat between the HEC element and the PCM. In operation, waste heat deposited into the HEC element due to passage of electric current is conducted to the PCM and cases it to melt. When the current is subsequently reduced, stored heat may be transferred from the PCM into environment or adjacent components. The exterior surface of the PCM may also include surface extensions such as undulations, groves, fins, or ribs to enhance transfer of stored heat to environment.

In a yet another embodiment of the subject invention, a plurality of HEC elements are helically wound over a PCM core made of PEX or HDPEX. In a still another embodiment of the subject invention, a plurality of generally rectangular HEC elements are stacked and interspaced with PEX or HDPEX PCM. In a further embodiment of the subject invention, a plurality HEX are imbedded in a PEX or HDPEX PCM matrix.

Accordingly, it is an object of the present invention to provide a lightweight electric conductor capable of intermittent operation at high currents. The conductor of the present invention is simple and robust, it is easy to manufacture, and it is suitable for large volume production.

It is another object of the invention to provide a lightweight electric conductor for hybrid electric vehicles.

It is still another object of the invention to provide a lightweight electric conductor for high-power microwave systems.

It is yet another object of the invention to provide a lightweight electric conductor for high-power laser systems.

It is yet further object of the invention to provide a electric conductor having an enhanced heat storage.

It is still further object of the invention to provide a thermal reservoir for an electric conductor.

These and other objects of the present invention will become apparent upon a reading of the following specification and claims.

### BRIEF DESCRIPTION OF THE DRAWINGS

FIG. 1 is a transverse cross-sectional view of the innovative conductor in accordance with one embodiment of the invention.

FIG. 2 is a transverse cross-sectional view of the innovative conductor in accordance with one embodiment of the invention showing surface extensions in the longitudinal cavity.

FIG. 3 is a longitudinal cross-sectional view of the innovative conductor of FIG. 1 showing the end plugs.

FIG. 4 is a transverse cross-sectional view of the innovative conductor in accordance with one embodiment of the invention showing void space for thermal expansion of PCM.

FIG. 5 is a transverse cross-sectional view the innovative conductor in accordance with another embodiment of the invention.

FIG. 6 is a transverse cross-sectional view of the innovative conductor in accordance with a yet another embodiment of the invention.

FIG. 7 is a transverse cross-sectional view of the innovative conductor in accordance with a still another embodiment of the invention.

FIG. 8 is a transverse cross-sectional view of the innovative conductor in accordance with a further embodiment of the invention.

### DETAILED DESCRIPTION OF THE PREFERRED EMBODIMENTS

Selected embodiments of the present invention will now be explained with reference to drawings. It will be apparent to those skilled in the art from this disclosure that the following descriptions of the embodiments of the present invention are merely exemplary in nature and are in no way intended to limit the invention, its application, or uses.

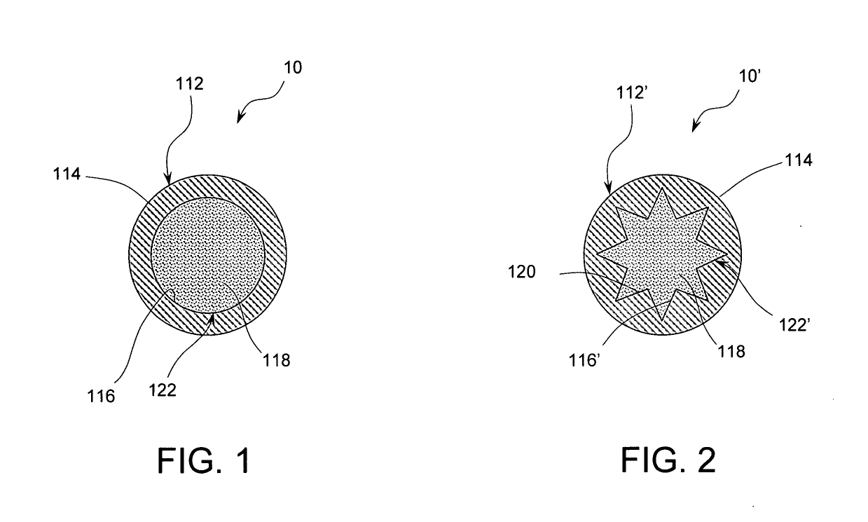

Referring to FIG. 1 of the drawings in detail, there is shown a transverse cross-sectional view of electric conductor assembly 10 in accordance with one embodiment of the subject invention. The electric conductor assembly 10 comprises a high electric conductivity (HEC) element 112 and a phase change material (PCM) 118. The HEC element 112 is preferably made of material having good electric conductivity. Most preferably the HEC element 112 is preferably made of material having high electric conductivity, such as but not limited to copper, copper alloys, aluminum, and aluminum alloys. The HEC element 112 may be formed as a generally parallelepiped (such as tubular or tube-like) member having an exterior surface 114 and an internal longitudinal cavity 122. The internal longitudinal cavity 122 preferably has a generally parallelepiped form. The transverse cross-section of the external surface 114 of the HEC element 112 may be formed in a variety suitable shapes including but not limited to circular shape, ellipsoidal shape, oval shape, triangular shape, rectangular shape, and polygonal shape. In addition, the external surface 114 may include surface extension such as protrusions, undulations, grooves, ribs, or fins. The cross-section of the cavity 122 may be formed in a variety suitable shapes including but not limited to, ellipsoidal shape, oval shape, triangular shape, rectangular shape, polygonal shape, and a star shape.

The PCM 118 may be arranged to substantially fill the longitudinal cavity 122 and arranged to be in a good thermal contact with the cavity wall 116. FIG. 2 shows a cross-sectional view of an electric conductor 10′, which is a variant of the electric conductor 10 having the HEC element 112′ and the PCM 118 wherein the thermal contact between the PCM and HEC may be enhanced by addition of surface extension 120 (such as protrusions, undulations, grooves, ribs, or fins) to the wall 116′ of the longitudinal cavity 122′. Any suitable PCM having a desired melting point, latent heat, and material compatibility may be used. Selection of PCM may depend on intended application and operation of the electric conductor 10. For many applications, PCM melting temperature may be selected to be in the range of 50 and 150 degrees Centigrade. For use in hybrid-electric vehicles, PCM melting temperature may be selected to be in the range of 80 and 150 degrees Centigrade, and preferably in the range of 80 and 120 degrees Centigrade.

Suitable PCM for use with the subject invention may include inorganic type materials and organic type materials. Certain suitable PCM may be found in articles entitled “Review on thermal energy storage with phase change: materials, heat transfer analysis and applications,” by B. Zalba et. al, in Applied Thermal Engineering, volume 23 (2003), pages 251-283, and “Latent heat storage materials and systems: A Review,” by S. D. Sharma and K. Sagara, in International Journal of Green Energy, volume 2 (2005), pages 1-56. Suitable inorganic PCM may include certain salts and salt hydrides. Corrosive effects of salt-type PCM on HEC element materials may be prevented by coating the cavity wall 116 with a suitable protective material such as a polymer coating. Suitable organic PCM may include certain organic acids, sugar alcohols, and polymers. A particularly suitable class of organic PCM compounds is disclosed by Lane et al. in U.S. Pat. No. 5,755,988 entitled “Dibasic acid based phase change material compositions,” then entire content of which is hereby expressly incorporated by reference. The higher molecular weight dibasic and monobasic acids are characterized by being largely non-hygroscopic and non-corrosive. Mixtures of organic acids have several advantages which make them particularly useful as PCMs. They melt without significant phase segregation, have low or no supercooling, and may be formulated over a broad range of melting temperatures.

Preferred PCM for use with the subject invention include paraffin waxes, PEX, HDPEX, benzoic acid (C₆H₅COOH), and erythritol (C₄H₁₀O₄). As already noted above, certain PCM may require addition of additives to reduce their supercooling to acceptable values. Such suitable additives for sugar alcohols (including erythritol) have been disclosed, for example, by Kakiuchi et. al in U.S. Pat. No. 5,785,885.

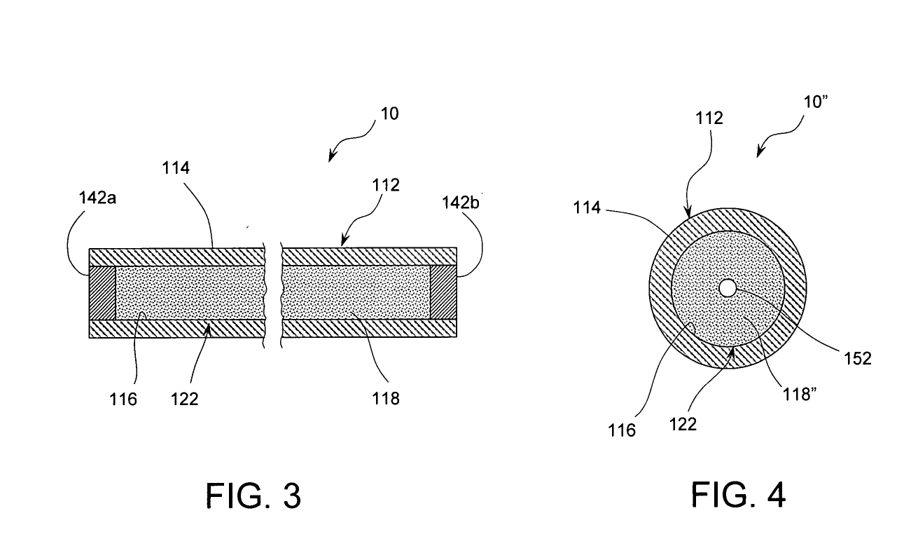

If the selected PCM has a tendency to become liquid upon melting, the ends of the longitudinal cavity may be plugged to prevent molten PCM from leaving the cavity. FIG. 3 shows a longitudinal cross-section of the electric conductor assembly 10 of FIG. 1 with end plugs 142a and 142b installed to prevent molten PCM 118 from leaking out of the cavity 122. For example, end plugs 142a and 142b may be press-fitted or bonded into the ends of the cavity 122.

The PCM 118 may also include a suitable elastic material or elastic objects that can accommodate density changes of the PCM due to melting or solidification without excessively increasing hydrostatic pressure in the PCM. It is well known that some PCM's such as certain types of paraffin have a solid density significantly higher than liquid density. On the other hand, some other PCM have a solid density significantly lower than liquid density. Presence of elastic members may avoid excessive pressure within the PCM and resulting excessive stresses to the HEC element 112. Suitable elastic material may be applied in strips, cords, rods or in a form of small particulates admixed into the PCM. Suitable elastic material may be a polymer, such as elastomeric material (e.g., rubber or latex) or expanded material (e.g., foam). The elastic material may be also applied in the form of solid or hollow objects. A suitable elastic material that may be provided in the form of elastic microspheres. See, for example, Kanno, et. al. in U.S. Pat. No. 6,217,891 and Abe in U.S. Pat. No. 6,015,606.

Another approach to avoiding excessive pressure in the PCM 118 due thermal expansion is to under-fill the cavity 122. Resulting void space inside the cavity 122 can allow for thermal expansion of the PCM without a build-up of excessive pressure. If the selected PCM does not turn into liquid upon melting, the PCM may be formed to have a well-defined void space allowing for thermal expansion of the PCM. FIG. 4 shows an electric conductor assembly 10″ having a PCM 118″ formed to have one or more void spaces 152. Suitable PCM 118″ includes a cross-linked polyethylene (PEX) which has a melting point in the range of 110-115 degrees Centigrade, and a cross-linked high-density polyethylene (HDPEX) which has a melting point in the range of 125-146 degrees Centigrade. PEX and HDPEX are known to contain cross-link bonds in the polymer structure, which change these thermoplastic materials into an elastomers. The cross-link bonds permit PEX and HDPEX to undergo a phase change transition (melting) accompanied by its characteristic absorption of heat without turning into liquid.

In operation, high electric current passing through the HEC element 112 generates waste heat that is deposited into the HEC material and raises its temperature. At least a portion of the waste heat is conducted to the PCM 118 and also raises its temperature. When the temperature of the PCM 118 reaches its melting temperature, further addition of waste heat gradually melts the PCM. As the waste heat is deposited into the latent heat of PCM 118, it may not significantly contribute to further temperature increase of the HEC element 112 and the PCM 118. The flow of electric current through the HEC element 112 is preferably reduced before all of the PCM 118 is melted. When the electric current is reduced, stored heat is gradually removed from the PCM 118 by conducting it back to the HEC element 112 and by transferring it from the exterior surface 114 of HEC element 112 to environment or adjacent components. The exterior surface 114 of the HEC element 112 may also include surface extensions such as undulations, groves, fins, or ribs to enhance transfer of heat from the conductor to environment.

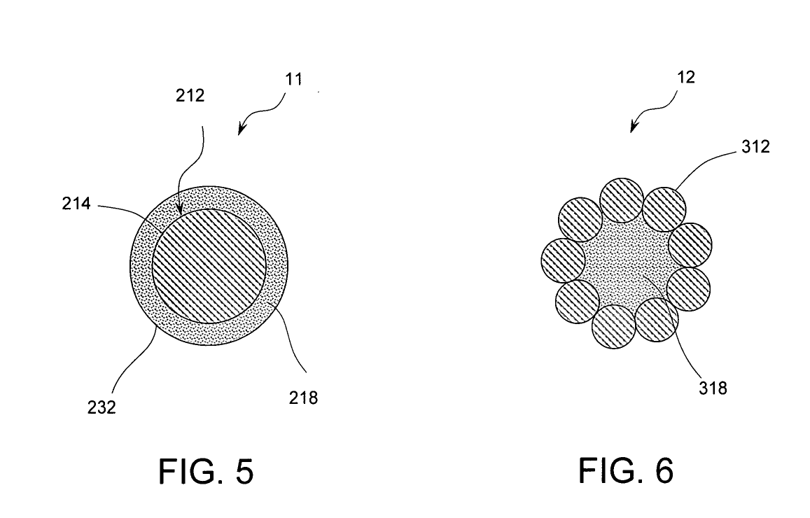

FIG. 5 shows a cross-sectional view of an electric conductor 11 in accordance with another embodiment of the subject invention. The electric conductor 11 comprises a high electric conductivity (HEC) element 212 and a phase change material (PCM) 218. The HEC element 212 is preferably made of material having good electric conductivity. Most preferably the HEC element 212 is preferably made of material having high electric conductivity, such as but not limited to copper, copper alloys, silver, silver alloys, aluminum, and aluminum alloys. The HEC element 212 may be formed as a long rod or a wire having an exterior surface 214. The cross-section of the external surface 214 of the HEC element 212 may be formed in a variety suitable shapes including but not limited to circular shape, ellipsoidal shape, oval shape, triangular shape, rectangular shape, polygonal shape, and star shape.

The PCM 218 may be applied to a part of or to the entire exterior surface 214. For example, the PCM 218 may form a jacket to the exterior surface 214 of the HEC element 212. Preferred PCM 218 for use with the electric conductor 11 include materials that do not turn into liquid upon melting. Examples of such materials include the already noted cross-linked polyethylene (PEX) and a cross-linked high-density polyethylene (HDPEX). The cross-link bonds in PEX and HDPEX permit these materials to undergo a phase change transition (melting) accompanied by its characteristic absorption of heat without turning into liquid. This allows PEX and HDPEX PCM to be used on the outside of HEC element 212 without encapsulation in another material. Since PEX and HDPEX are electrically insulating materials, they may simultaneously provide two functions: electric insulation and heat storage. The exterior surface 232 of the PCM 218 may include surface extensions such as protrusions, undulations, grooves, fins, or ribs to enhance transfer of heat between the HEC element and the PCM. In operation, waste heat deposited into the HEC element 212 due to passage of electric current is conducted to the PCM 218 and it is deposited therein by causing the PCM to at least partially melt. When the current is appropriately reduced, stored heat may be transferred from the PCM 218 through the surface 232 by convection into environment or by conduction to adjacent components. The exterior surface of the PCM may also include surface extensions such as undulations, groves, fins, or ribs to enhance transfer of stored heat to environment.

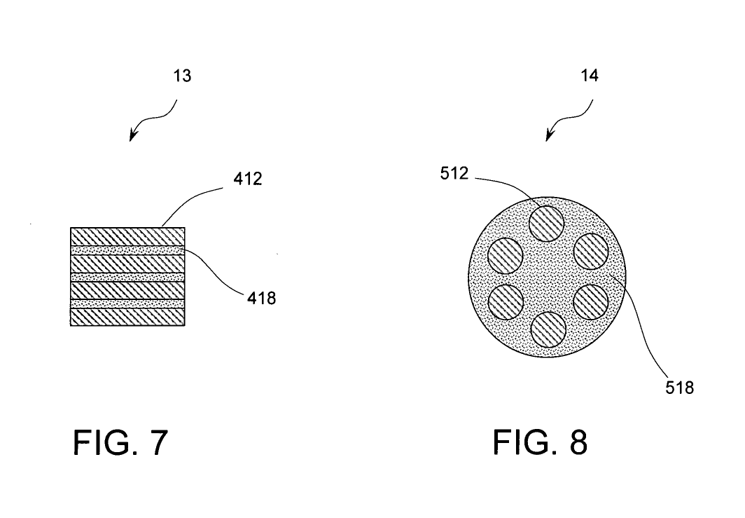

Referring now to FIG. 6, there is shown a cross-sectional view of an electric conductor assembly 12 in accordance with a yet another embodiment of the subject invention. The electric conductor assembly 12 comprises a plurality of HEC elements 312 helically wound over a PCM core 318 made of PEX or HDPEX. FIG. 7 shows a cross-sectional view of an electric conductor assembly 13 in accordance with a still another embodiment of the subject invention. The electric conductor assembly 13 comprises a plurality of generally parallel HEC elements 412 arranged in stack and interspaced with PEX or HDPEX PCM 418.

FIG. 8 shows a cross-sectional view of an electric conductor assembly 14 in accordance with a further embodiment of the subject invention. The electric conductor assembly 14 comprises a plurality of generally parallel HEC elements 512 imbedded in a PEX or HDPEX PCM matrix 518.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

Heat transfer fluids suitable for use with the subject invention include 1) liquids such as water, aqueous solution of alcohol, antifreeze, and oil, 2) gases including air, helium, and nitrogen, and 3) vapors such water steam, Freon, and ammonia.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

What is claimed is:

1. An electric conductor assembly comprising:
a) a high electric conductivity (HEC) element formed as a parallelepiped member having an external surface; and
b) a phase change material (PCM) in thermal contact with said HEC element.

2. The electric conductor assembly of claim 1 further comprising at least one surface extension on said wherein said external surface; said surface extension being selected from the family consisting of protrusion, undulation, groove, rib, and fin.

3. The electric conductor assembly of claim 2 wherein said PCM is in thermal communication with said external surface.

4. The electric conductor assembly of claim 1 further comprising a parallelepiped internal cavity inside said parallelepiped member.

5. The electric conductor assembly of claim 4 further comprising end caps substantially closing said parallelepiped internal cavity.

6. The electric conductor assembly of claim 4 wherein said PCM substantially fills said parallelepiped internal cavity.

7. The electric conductor assembly of claim 6 further comprising a void space inside said parallelepiped internal cavity, said void space not being filled by said PCM.

8. An electric conductor assembly comprising:
a) a high electric conductivity (HEC) element formed as a tubular member having a an external surface and a longitudinal internal cavity; and
b) a phase change material (PCM) at least partially filling said longitudinal internal cavity, said PCM being in thermal contact with said HEC element.

9. The electric conductor assembly of claim 8 wherein said HEC element is formed from a material selected from the group consisting of copper, copper alloy, aluminum, and aluminum alloy.

10. The electric conductor assembly of claim 8 further comprising at least one surface extension on the wall of said longitudinal internal cavity.

11. The electric conductor assembly of claim 8 further comprising end caps substantially closing said longitudinal internal cavity.

12. The electric conductor assembly of claim 11 wherein said PCM is selected from the group consisting of benzoic acid (C₆H₅COOH), erythritol (C₄H₁₀O₄), dibasic acid, monobasic acid, salt, salt hydride.

13. The electric conductor assembly of claim 8 wherein said PCM is selected from the group consisting of cross-linked polyethylene (PEX) and a cross-linked high-density polyethylene (HDPEX).

14. The electric conductor assembly of claim 8 further comprising at least one surface extension on said external surface of said HEC element; said surface extension being selected from the family consisting of protrusion, undulation, groove, rib, and fin.

15. The electric conductor assembly of claim 8 further comprising a void space inside said longitudinal internal cavity, said void space not being filled by said PCM.

16. The electric conductor assembly of claim 8 further comprising elastic material within said PCM.

17. An electric conductor assembly comprising:
a) a high electric conductivity (HEC) element;
said HEC element having a form selected from the group consisting of
a wire, bar, and rod;
b) and a phase change material (PCM);
said PCM arranged in a in thermal contact with said HEC element;
said PCM selected from the group consisting of cross-linked polyethylene (PEX) and a cross-linked high-density polyethylene (HDPEX).

18. The electric conductor assembly of claim 17 wherein said HEC element is helically wound over said PCM.

19. The electric conductor assembly of claim 17 further comprising at least one surface extension on the external surface of said HEC element; said surface extension being selected from the family consisting of protrusion, undulation, groove, rib, and fin.

20. The electric conductor assembly of claim 19 wherein said PCM is in physical and thermal contact with said surface extension.

21. The electric conductor assembly of claim 19 wherein said HEC element is substantially imbedded inside said PCM.
